(19) United States
(12) Patent Application Publication
(10) Pub. No.: US 2025/0289037 A1
(43) Pub. Date: Sep. 18, 2025

(54) Spraying device and pressure cleaning device with a spraying device

(71) Applicant: Andreas Stihl AG & Co. KG, Waiblingen (DE)

(72) Inventors: Yannic Müller, Backnang (DE); Michael Renz, Stuttgart (DE); Mario Häfele, Wüstenrot (DE)

(73) Assignee: Andreas Stihl AG & Co. KG, Waiblingen (DE)

(21) Appl. No.: 19/076,901

(22) Filed: Mar. 11, 2025

(30) Foreign Application Priority Data
Mar. 13, 2024 (EP) 24163254.6

(51) Int. Cl. B08B 3/02

(52) U.S. Cl. CPC B08B 3/026; B08B 2203/02

(57) ABSTRACT

A spraying device for a pressure cleaning device (1) includes a base body (10), a spraying head (20) with a spraying opening (21) through which cleaning fluid can be sprayed, a lance (30) which can be arranged between the base body (10) and the spraying head (20), a base connection device (40) by which the lance (30) can be detachably connected to the base body (10) and a head connection device (50) by which the lance (30) can be detachably connected to the spraying head (20). The cleaning fluid can be conveyed from the base body (10), in particular through the lance (30), to the spraying opening (21). The base connection device (40) can be detached with a base detachment force. The head connection device (50) can be detached with a head detachment force. The base detachment force and the head detachment force are of different magnitude.

### CROSS-REFERENCE TO RELATED APPLICATION

This application claims the benefit of European Patent Application EP 24163254.6, filed on Mar. 13, 2024, the content of which is incorporated in its entirety.

### TECHNICAL FIELD

The disclosure relates to a spraying device.

### BACKGROUND

Pressure cleaning devices, or pressure washers, have a base body, in particular with a handle, and a spraying head with a spraying opening through which cleaning fluid can be sprayed. A lance can be arranged between the base body and the spraying head. Typically, the lance can be detachably connected to the base body by a base connection device, which may also be referred to as a base coupling. In particular, the lance can be detachably connected to the spraying head by means of a head connection device, which may also be referred to as a head coupling. In the connected state, cleaning fluid can be conveyed from the base body to the spraying opening, in particular through the lance.

### SUMMARY

The disclosure improves a generic spraying device such that unintentional detachment of a connecting device is reliably avoided. This is achieved by a spraying device as disclosed and claimed.

The spraying device is configured such that a base connection device can be detached with a base detachment force. A head connection device can be detached with a head detachment force. The base detachment force and the head detachment force are of different magnitude. The smaller of the two detachment forces determines which of the two connection devices can be detached more easily. The other of the two connection devices, which is assigned the greater detachment force, is protected against unintentional detachment. This is because, when a detachment force is applied, the connection device assigned the smaller detachment force is detached first.

In particular, the greater of the two detachment forces is at least 105%, in particular at least 110%, in particular at least 150% of the smaller detachment force.

In particular, the cleaning fluid can be conveyed from the base body through the lance to the spraying opening. In particular, the cleaning fluid is guided directly in the lance. The lance comprises, in particular, a channel which is formed by an inner wall of the lance. The cleaning fluid flows, in particular, along the inner wall and hereby comes into direct contact with the inner wall. In particular, there is no hose designed separately from the lance for guiding the cleaning fluid.

In particular, the cleaning fluid flows through the base connection device and the base connection device itself seals the spraying device to the outside against leakage of cleaning fluid.

In particular, the cleaning fluid flows through the head connection device and the head connection device itself seals the spraying device to the outside against leakage of cleaning fluid.

In particular, the base body comprises a handle.

In particular, the base connection device is detachable with the base detachment force such that the lance can be reversibly separated from the base body. In particular, the head connection device is detachable with the head detachment force such that the spraying head can be reversibly separated from the lance.

The head detachment force is advantageously smaller than the base detachment force. When a user applies a detachment force, the head connection device is detached before the base connection device. This makes it possible, for example, to detach the spraying head without simultaneously detaching the lance from the base body. This reliably prevents the base connection device from being detached unintentionally.

In an advantageous refinement, the spraying device comprises at least a first spraying head and a second spraying head. The spraying device can advantageously be used optionally with the first spraying head or with the second spraying head. In particular, the first and second spraying heads have different properties. Preferably, the first spraying head and the second spraying head have different nozzles. This allows the spraying device to be adapted to the respective application. In particular, if the head detachment force is smaller than the base detachment force, it is easy to switch between the first spraying head and the second spraying head. When exchanging the first spraying head for the second spraying head or vice versa, it is then reliably avoided that the base connection device is unintentionally detached first. This prevents the lance from being unintentionally detached from the base body, in particular even though only the spraying head was supposed to be detached from the lance.

The base connection device expediently comprises a base element on the base body and a base lance element on the lance. In particular, the head connection device comprises a head element on the spraying head and a head lance element on the lance.

The spraying device is preferably designed such that the spraying head can be fastened directly to the base body without the interposition of the lance. In particular, the spraying device is designed such that the direct connection can be established through the interaction of the head element of the head connection device and the base element of the base connection device. This means that the spraying device can be used optionally with or without a lance. When used without a lance, the spraying head is connected to the base body through the interaction of the head element of the head connection device and the base element of the base connection device. The head element of the head connection device and the base element of the base connection device thus form a short connection device. When the spraying device is used with a lance, the lance is connected to the base body by means of the base connection device and the spraying head is connected to the lance by means of the head connection device. This means that the spraying device can be used optionally with or without a lance.

Advantageously, the base connection device and/or the head connection device is, or at least also, a rotary connection. In particular, the base connection device and/or the head connection device can be detached and/or closed by means of a rotary movement, in particular in the circumferential direction of the lance. In particular, the circumferential direction runs around a spraying direction of the spraying device. The spraying direction is the direction in which a liquid is sprayed from the spraying device. In particular, the spraying direction runs in the longitudinal direction of the lance. In particular, the base connection device can be detached and/or closed by a relative movement of the base element and base lance element with respect to the circumferential direction. In particular, the head connection device can be detached and/or closed by a relative movement of the head element and head plant element with respect to the circumferential direction.

In an advantageous refinement, the base connection device and/or the head connection device comprises a bayonet catch. In particular, the base connection device and/or the head connection device is a bayonet catch. A bayonet catch is a mechanical connection of two at least partially cylindrical parts along their longitudinal axis that can be quickly produced and detached. The parts are connected and therefore also separated again by inserting them into one another and turning them in opposite directions. In particular, one of the two parts has a longitudinal guide which extends along the longitudinal axis of the cylindrical design. The longitudinal guide runs from one edge of this part to an inner end of the part. A transverse guide adjoining the longitudinal guide runs transversely to the longitudinal guide. The other of the two parts has a counter contour that is configured to engage in the longitudinal and transverse guides. The counter contour may be a projection, for example. When connecting the bayonet catch, the counter contour is first inserted into the longitudinal guide and then moved in the longitudinal direction to the end of the longitudinal guide. The counter contour is then introduced into the transverse guide by rotating the two parts relative to each other around the longitudinal axis. This creates a firm connection. In particular, the connection is made via a stretching/rotating movement or an axial/rotating movement. Typically, the transverse guide runs diagonally from the end of the longitudinal guide towards the edge of the part with the longitudinal guide. Provision can be made for the counter contour to be preloaded towards the edge of the first part by a spring in the transverse guide. At least two longitudinal and two transverse guides are typically provided. Accordingly, at least two counter contours are typically provided. The bayonet catch provides a simple and inexpensive type of connection.

In an advantageous refinement, the spraying device comprises a base securing element for securing the base connection device against detachment. Alternatively or in addition, provision can be made for the spraying device to comprises a head securing element for securing the head connection device against detachment. This can prevent the connection devices from becoming unintentionally detached.

In particular, the head detachment force must at least also be applied against a head securing force provided by the head securing element. Alternatively or in addition, provision can be made for the base detachment force also to have to be applied against a base securing force provided by the base securing element. In particular, the head securing force and the base securing force differ in their amount. The base securing force is advantageously greater than the head securing force. This ensures that the head connection is detached before the base connection. In particular, the head securing force and the base securing force act in the same direction. In particular, the head detachment force and the base detachment force act in the same direction.

The base securing element is advantageously a first spring. The head securing element is expediently a second spring. This means that the head securing force and the base securing force can be provided in a simple manner. The base securing element and the head securing element are easy to manufacture.

The spring hardnesses of the first spring and the second spring are expediently of different magnitude. In particular, the spring hardness of the first spring is greater than the spring hardness of the second spring.

The lance extends in a longitudinal direction from the base body to the spraying head. In particular, the base securing element acts in the longitudinal direction of the lance. The head securing element expediently acts in the longitudinal direction of the lance. In particular, to detach the head connection, a head detachment force must be applied which acts at least also in the longitudinal direction of the lance or against the longitudinal direction of the lance. In particular, to detach the base connection, a base detachment force must be applied which acts in the longitudinal direction or against the longitudinal direction of the lance. This ensures that the base connection device and the head connection device are easily secured against unintentional detachment.

The base securing element expediently pushes the base body and the lance apart with respect to the longitudinal direction. Alternatively or in addition, provision can be made for the head securing element to push the lance and the spraying head apart with regard to the longitudinal direction.

In an advantageous refinement, the base connection device is designed such that it can be seen from outside whether the base connection device is in a closed state or in an open state. Alternatively or in addition, provision can be made for the head connection device to be designed such that it is clear from the outside whether the head connection device is in a closed state or in an open state. This allows the user to easily check whether the spraying device is ready for use, in particular whether the lance or the spraying head is correctly mounted. In addition, the user can easily see the direction in which the head detachment force or the base detachment force must act to detach the head connection device or the base connection device.

The bayonet catch has a male part and a female part. A window, in particular an aperture, is expediently provided on the female part so that it can be seen from outside whether the male part is within the female part in the closed position.

A pressure cleaning device advantageously comprises a spraying device as disclosed herein.

A lance for a spraying device or for a pressure cleaning device forms part of the base connection device and part of the head connection device. For this purpose, the lance has a base lance element and a head lance element. The base lance element is designed in particular to form the base connection device together with a base element on the base body of a pressure cleaning device. The head lance element is expediently designed to form the head connection device together with a head element on a spraying head of a pressure cleaning device.

In particular, the pressure cleaning device is intended for spraying a cleaning fluid. The pressure cleaning device expediently puts the cleaning fluid under pressure. In particular, the pressure cleaning device has a pump. The cleaning fluid in the pressure cleaning device can expediently be put under pressure by means of the pump. The cleaning fluid can advantageously be put under a pressure of at least 10 bar, in particular of at least 15 bar, in particular of at least 30 bar, in particular of at least 100 bar by means of the pump. In particular, the cleaning fluid can be put under a pressure of at most 600 bar, in particular of at most 500 bar, using the pump. In particular, the pressure cleaning device is a high-pressure cleaning device.

### BRIEF DESCRIPTION OF THE DRAWINGS

Exemplary embodiments of the invention are described below by reference to the drawings.

FIG. 1 shows a perspective view of a pressure cleaning device comprising a base body, a spraying head and a lance.

FIG. 2 shows a sectional view of a section through the pressure cleaning device from FIG. 1, with the cutting plane running through the longitudinal axis of the lance.

FIG. 3 shows an exemplary, perspective, partially sectioned view of a head connection device or a base connection device.

FIG. 4 shows a perspective view of the male part of the head connection device or the base connection device.

FIG. 5 shows a perspective view of the female part of the head connection device or the base connection device.

FIG. 6 shows a perspective view of the pressure cleaning device from FIG. 1 without a lance, the spraying head being mounted on the base body.

FIG. 7 shows a perspective view of an alternative exemplary embodiment of a spraying device comprising a base body, a spraying head and a lance, there being no pump arranged in the spraying device.

### DETAILED DESCRIPTION

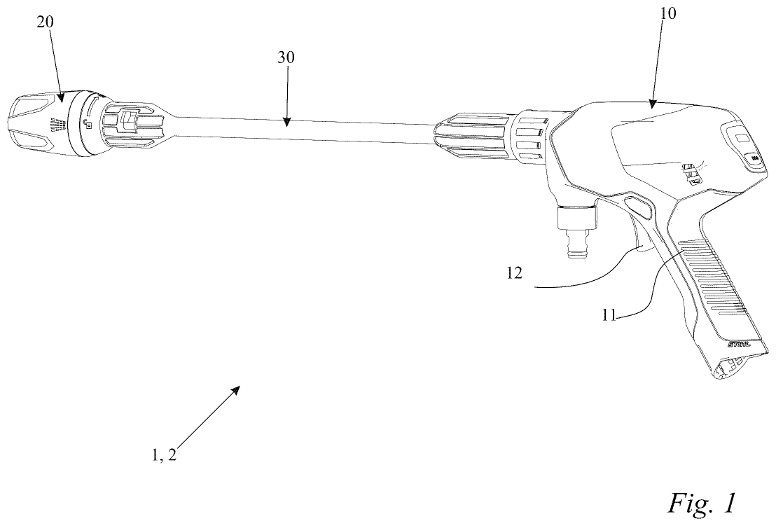

FIG. 1 shows a pressure cleaning device 1. The pressure cleaning device 1 is used to spray a cleaning fluid pressurized by the pressure cleaning device 1. The pressure cleaning device 1 comprises a spraying device 2. The spraying device 2 can be guided by hand when the pressure cleaning device 1 is used as intended. In the exemplary embodiment according to FIGS. 1, 2 and 6, the entire pressure cleaning device 1 can be guided by hand when used as intended.

The pressure cleaning device 1 can put the cleaning fluid under a pressure of at least 10 bar, in particular of at least 15 bar, in particular of at least 30 bar, in particular of at least 100 bar. In particular, the pressure cleaning device 1 can put the cleaning fluid under a pressure of at most 600 bar, in particular of at most 500 bar. In the exemplary embodiments, the pressure cleaning device 1 is a high-pressure cleaning device.

The spraying device 2 comprises a base body 10, a spraying head 20 and a lance 30. The base body 10 has in particular a handle 11. The spraying device 2, in particular the pressure cleaning device 1, can be held and guided by the user during use using the handle 11. An operating element 3 is arranged on the base body 10. The spraying of cleaning fluid can be influenced, in particular controlled, by an operator using the operating element 3. In particular, by operating the operating element 3, a valve can be opened, which then allows the flow of cleaning fluid and enables the cleaning fluid to be sprayed. When holding the handle 11 with one hand, the operator can operate the operating element 3 with the same hand, in particular with a three-jointed finger of the same hand.

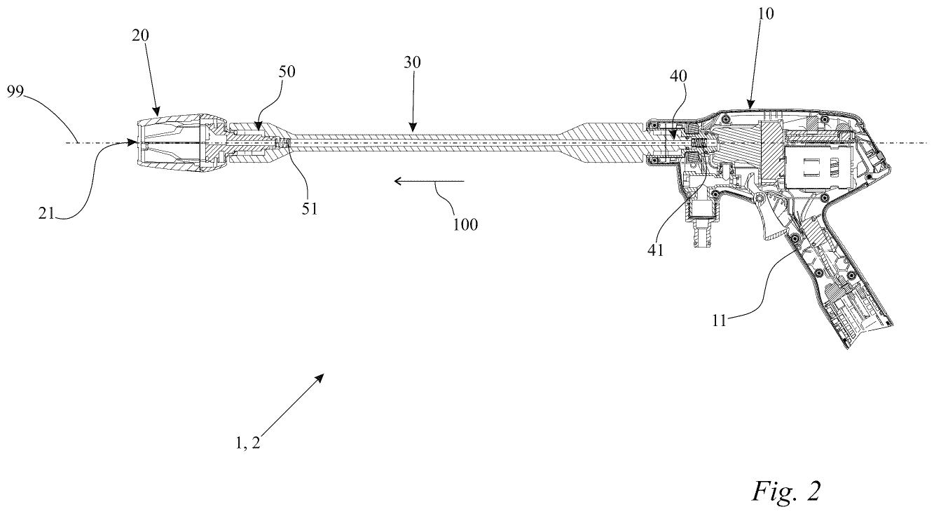

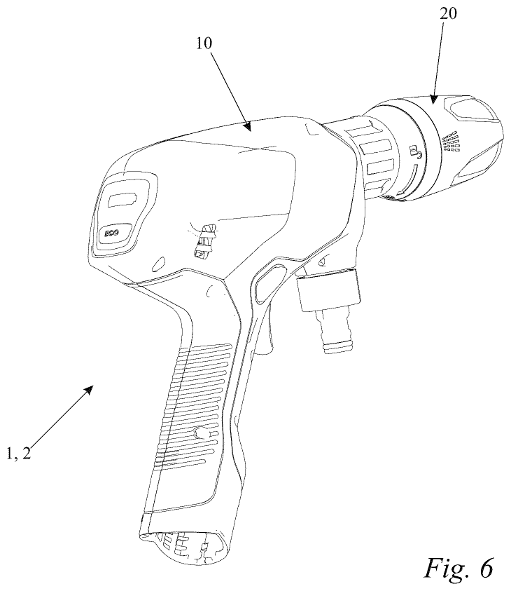

The cleaning fluid can be sprayed through the spraying head 20. For this purpose, the spraying head 20 has a spraying opening 21 (FIG. 2). The lance 30 can be arranged between the base body 10 and the spraying head 20. FIGS. 1 and 2 show the spraying device 2 with the lance 30 arranged between the spraying head 20 and the base body 10. FIG. 6 shows the use of the spraying device 2, in particular the pressure cleaning device 1, without the lance 30. The spraying head 20 can expediently be arranged optionally directly on the lance 30 or directly on the base body 10. If the spraying head 20 is arranged directly on the base body 10, the pressure cleaning device 2 can be used without the lance 30.

As shown in FIG. 2, the pressure cleaning device 1 comprises a base connection device 40. The lance 30 can be detachably connected to the base body 10 by means of the base connection device 40. In FIGS. 1 and 2, the lance 30 is detachably connected to the base body 10 by means of the base connection device 40. The pressure cleaning device 1 comprises a head connection device 50. The lance 30 can be detachably connected to the spraying head 20 by means of the head connection device 50. In FIGS. 1 and 2, the lance 30 is detachably connected to the spraying head 20 by means of the head connection device 50.

FIGS. 1 and 2 show the spraying device 2 in an extended state. In the extended state, the lance is arranged between the base body 10 and the spraying head 20. Cleaning fluid can be conveyed from the base body 10 through the lance 30 to the spraying opening 21 of the spraying head 20. In particular, the cleaning fluid is guided directly in the lance 30. The lance 30 comprises, in particular, a channel which is formed by an inner wall of the lance 30. The cleaning fluid flows, in particular, along the inner wall and hereby comes into direct contact with the inner wall. In particular, there is no hose designed separately from the lance 30 for guiding the cleaning fluid.

In particular, the cleaning fluid flows through the base connection device 40 and the base connection device 40 itself seals the spraying device 2 to the outside against leakage of cleaning fluid.

In particular, the cleaning fluid flows through the head connection device 50 and the head connection device 50 itself seals the spraying device 2 to the outside against leakage of cleaning fluid.

FIG. 6 shows the spraying device 2 in a short state. In the short state of the spraying device 2, the lance 30 is removed. The spraying head 20 is directly connected to the base body 10, in particular without the interposition of the lance 30. Cleaning fluid can be conveyed from the base body 10 directly into the spraying head 20 and to the spraying opening 21.

The base connection device 40 shown in FIGS. 1 and 2 can be detached using a base detachment force. After the base connection device 40 has been detached, the lance 30 can be separated from the base body 10. The lance 30 is then no longer connected to the base body 10. The base connection device 40 can be detached without tools. The base detachment force can be applied by a user without any additional aids. The head connection device 50 can be detached with a head detachment force. After the head connection device 50 has been detached, the spraying head 20 can be separated from the lance 30. The spraying head 20 is then longer connected to the lance 30. The head connection device can be detached without tools. The head detachment force can be applied by a user without any additional aids. The base detachment force and the head detachment force are of different magnitude.

In particular, the greater of the two detachment forces is at least 105%, in particular at least 110% of the smaller detachment force. In the exemplary embodiments, the greater of the two detachment forces is at least 150% of the smaller detachment force.

The head detachment force is smaller than the base detachment force.

Provision can be made for the spraying device 2 to comprise at least a first spraying head and a second spraying head (not shown in the figures). The spraying device can then be used optionally with the first spraying head or with the second spraying head. The first spraying head and the second spraying head have different properties. In particular, the first spraying head and the second spraying head can have different nozzles. For example, the first spraying head can have a point jet nozzle or a round jet nozzle. The second spraying head can have a flat jet nozzle.

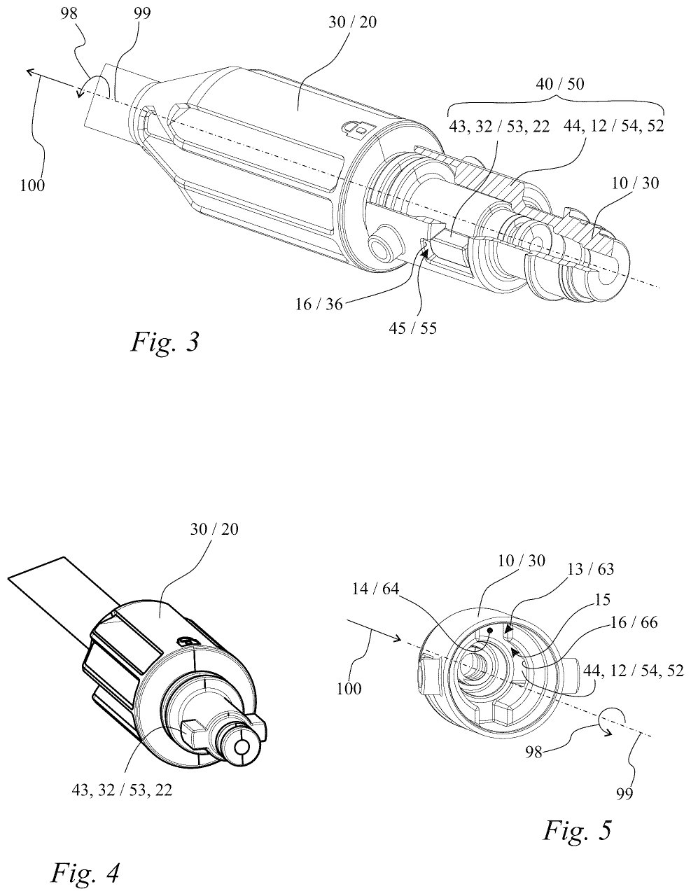

FIG. 3 shows, by way of example, a perspective view of a base connection device 40 or a head connection device 50. In FIG. 3, at least two reference numerals are given for each component. The respective reference numerals are separated from one another by a forward slash. The first reference numeral mentioned in each case refers to the base connection device 40. The second reference numeral respectively refers to the head connection device 50. The reference numerals in FIGS. 4 and 5 are assigned in a similar way. The base connection device 40 will first be described below with reference to FIGS. 3, 4 and 5. For this description, therefore, only the reference numerals before the forward slash are relevant.

As shown in FIG. 3, the base connection device 40 comprises a base element 12 and a base lance element 32. The base element 12 is part of the base body 10. The base lance element 32 is part of the lance 30. The base element 12 corresponds to the base lance element 32.

To produce the base connection between the base body 10 and the lance 30, the base element 12 and the base lance element 32 engage with one another. In the exemplary embodiments, the base element 12 of the base body 10 forms a male part 43 of the base connection device 40. The base lance element 32 forms a female part 44 of the base connection device 40. As shown in FIG. 4, the base lance element 32 of the lance 30 is formed by at least one projection in the exemplary embodiments. A longitudinal direction 100 is shown in FIG. 2. The longitudinal direction 100 is the direction of the longitudinal extent of the lance 30. The longitudinal direction 100 corresponds to the spraying direction in which the cleaning fluid is sprayed from the spraying head 20. The base lance element protrudes in the direction radial to the longitudinal direction 100. In the exemplary embodiments, two base lance elements 32 are provided. The two base lance elements 32 are opposite each other in the direction transverse to the longitudinal direction 100, in particular in the direction perpendicular to the longitudinal direction 100.

FIG. 5 shows the base element 12 of the base connection device 40, which is formed on the base body 10. The base element 12 is a guide element for receiving and guiding the base lance element 32. In the exemplary embodiments, the base element 12 is a guide groove. However, provision can also be made for the base element to be a slot. The guide groove extends from an edge of the base element 12, from which the base lance element 32 is introduced into the base element 12, at least partially in the direction opposite to the longitudinal direction 100. The part of the guide groove extending in the direction opposite to the longitudinal direction 100 is referred to as the longitudinal groove 13. The longitudinal groove 13 has an end 14 in the direction opposite to the longitudinal direction 100. A transverse groove 15 extends from the end 14 of the longitudinal groove 13. The transverse groove 15 is part of the guide groove of the base element 12. The transverse groove 15 runs in a direction transverse to the longitudinal groove 13. As shown in FIG. 2, the lance 30 has a longitudinal centre axis 99. The longitudinal centre axis 99 extends in the longitudinal direction 100. A circumferential direction 98 runs around the longitudinal axis 99. The transverse groove 15 shown in FIG. 5 runs at least partially in the circumferential direction 98 around the longitudinal centre axis 99. The transverse groove 15 extends from the end 14 of the longitudinal groove 13 in the circumferential direction 98. With respect to the longitudinal direction 100, the transverse groove 15 has a locking recess 16 shown in FIGS. 3 and 5. In the area of the locking recess 16, the transverse groove 15 of the guide groove allows the base lance element 32 to be positioned further in the direction of the longitudinal direction 100 than in the remaining part of the transverse groove 15. The locking recess 16 extends with respect to the circumferential direction 98 only over a partial area of the transverse groove 15. When the base lance element 32 or the male part 43 of the base connection device 40 is positioned with its projection in the locking recess 16 and rests in the locking recess 16, a movement of the base lance element 32 in the direction of the longitudinal groove 13 with respect to the circumferential direction 98 is prevented.

As shown in FIG. 2, the spraying device 2 comprises a base securing element 41. The base securing element 41 serves to secure the base connection device 40 against detachment. The base securing element 41 acts in the longitudinal direction 100. When the base connection device 40 is closed, the base securing element 41 presses the base lance element 32 into the locking recess 16 of the guide groove. This prevents movement, in particular rotational movement, of the base lance element 32 in the circumferential direction 98, in particular about the longitudinal centre axis 99. The base securing element 41 presses the base body 10 and the lance 30 apart with respect to the longitudinal direction 100. The base lance element 32 is secured in the base element 12. In the exemplary embodiments, the base securing element 41 is a first spring. However, provision can also be made for the base securing force to be provided in another way. For example, this can be achieved by frictional force which acts between the base element and the base lance element when the base connection device is connected. The base lance element and the base element then engage with each other in a frictional manner. Provision can be made for the base securing force to act exclusively by frictional force.

The base detachment force for detaching the base connection device 40 acts in the longitudinal direction 100. In particular, the base detachment force acts in the longitudinal direction 100 against the base securing force of the base securing element 41. In the exemplary embodiments, the base detachment force to be applied in the longitudinal direction 100 is to be applied to detach the base connection device 40. A pivoting movement of the base element 12 relative to the base lance element 42 in the circumferential direction 98 is then required in order then to be able to remove the lance 30 from the base body 10 by a relative movement of the base element 12 and the base lance element 32 in the longitudinal direction 100.

The base connection device 40 comprises a bayonet catch. In the exemplary embodiments, the base connection device 40 is a bayonet catch. The bayonet catch of the base connection device 40 comprises the male part 43 and the female part 44.

The base connection device 40 is designed such that it can be seen from outside whether it is in a closed state or in an open state. The base connection device 40 is designed such that the projection of the base lance element 32, in particular the male part 43, can be seen from outside the base connection device 40, in particular from outside the spraying device 2, in particular from outside the pressure cleaning device 1, when the base connection device 40 is closed. A window 45 is provided on the base element 12, in particular on the female part 44, as shown in FIG. 3. The window 45 is an aperture through an outer wall of the base element 12. When the base connection device 40 is closed, the outer wall at least partially encloses the base lance element 32. When the base connection device 40 is closed, the outer wall of the base element 12 runs at least partially enclosed around the base lance element 32 in a circumferential direction 98. The projection of the base lance element 32 is arranged in the area of the window 45 in the base element 12 when the base connection device 40 is closed. The locking recess 16 of the guide groove is arranged in the area of the window 45. In the exemplary embodiments, the locking recess 16 is part of the edge limit of the window 45. Through the window 45 it is possible to see from outside whether the base lance element 32 is within the base element 12 when the base connection device 40 is in the closed position. Through the window 45 it is possible to see from outside whether the male part 43 is within the female 44 when in the closed position.

The interaction of the head element 22 of the spraying head 20 and the head lance element 52 of the lance 30 will be described below with reference to FIGS. 3 to 5. The renewed description of FIGS. 3 to 5 therefore does not relate to the base connection device 40 as above, but to the head connection device 50. The base connection device 40 and the head connection device 50 are designed largely analogously in the exemplary embodiments. FIGS. 3 to 5 therefore serve as examples to illustrate both the base connection device 40 and the head connection device 50. For the following description of the head connection device 50, only the numbers after the forward slash in the reference numerals in FIGS. 3 to 5 are relevant.

As shown in FIG. 3, the head connection device 50 comprises a head element 22 and a head lance element 52. The head element 22 is part of the spraying head 20. The head lance element 52 is part of the lance 30. The head element 22 corresponds to the head lance element 52.

To produce the base connection between the lance 30 and the spraying head 20, the head element 22 and the head lance element 52 engage with one another. In the exemplary embodiments, the head element 22 of the spraying head 20 forms a male part 53 of the head connection device 50. The head lance element 52 forms a female part 54 of the head connection device 50. As shown in FIG. 4, the head lance element 52 of the lance 30 is formed by at least one projection in the exemplary embodiments. The head element 22 protrudes in the direction radial to the longitudinal direction 100. In the exemplary embodiments, two head elements 32 are provided. The two head elements 32 are opposite each other in the direction transverse to the longitudinal direction 100, in particular in the direction perpendicular to the longitudinal direction 100.

FIG. 5 shows the head lance element 52 of the head connection device 50, which is formed on the spraying head 20. The head lance element 52 is a guide element for receiving and guiding the head element 22. In the exemplary embodiments, the head lance element 52 is a guide groove. However, provision can also be made for the head lance element to be a slot. The guide groove extends from an edge of the head lance element 52, from which the base head element 22 is introduced into the head lance element 52, at least partially in the direction opposite to the longitudinal direction 100. The part of the guide groove extending in the direction opposite to the longitudinal direction 100 is referred to as the longitudinal groove 63. The longitudinal groove 63 has an end 64 in the direction opposite to the longitudinal direction 100. A transverse groove 65 extends from the end 64 of the longitudinal groove 63. The transverse groove 65 is part of the guide groove of the head lance element 52. The transverse groove 65 runs in a direction transverse to the longitudinal groove 63. The transverse groove 65 shown in FIG. 5 runs at least partially in the circumferential direction 98 around the longitudinal centre axis 99. The transverse groove 65 extends from the end 64 of the longitudinal groove 63 in the circumferential direction 98. With respect to the longitudinal direction 100, the transverse groove 65 has a locking recess 66 shown in FIGS. 3 and 5. In the area of the locking recess 66, the transverse groove 65 of the guide groove allows the head element 22 to be positioned further in the direction of the longitudinal direction 100 than in the remaining part of the transverse groove 65. The locking recess 66 extends with respect to the circumferential direction 98 only over a partial area of the transverse groove 65. When the head element 22 or the male part 43 of the head connection device 50 is positioned with its projection in the locking recess 66 and rests in the locking recess 66, a movement of the head element 22 in the direction of the longitudinal groove 63 with respect to the circumferential direction 98 is prevented.

As shown in FIG. 2, the spraying device 2 comprises a head securing element 51. The head securing element 51 serves to secure the head connection device 50 against detachment. The head securing element 51 acts in the longitudinal direction 100. When the head connection device 50 is closed, the head securing element 51 presses the head lance element 52 into the locking recess 66 of the guide groove. This prevents movement, in particular rotational movement, of the head element 22 in the circumferential direction 98, in particular about the longitudinal centre axis 99. The head securing element 51 presses the lance 30 and the spraying head 20 apart with respect to the longitudinal direction 100. The head element 22 is secured in the head lance element 52. In the exemplary embodiments, the head securing element 51 is a second spring.

The head detachment force for detaching the head connection device 50 acts in the longitudinal direction 100. In particular, the head detachment force acts in the longitudinal direction 100 against the head securing force of the head securing element 51. In the exemplary embodiments, the head detachment force to be applied in the longitudinal direction 100 is to be applied to detach the head connection device 50. A pivoting movement of the head element 22 relative to the head lance element 52 in the circumferential direction 98 is then required in order then to be able to remove the spraying head 20 from the lance 30 by a relative movement of the head element 22 and the head lance element 52 in the longitudinal direction 100.

However, provision can also be made for the head securing force to be provided in another way. For example, this can be achieved by frictional force which acts between the head element and the head lance element when the head connection device is connected. The head lance element and the head element then engage with each other in a frictional manner. Provision can be made for the head securing force to act exclusively by frictional force. In such an embodiment, the head securing force and the base securing force are also of different magnitude. In particular, the base securing force is greater than the head securing force, especially in the percentage ratios mentioned above for the head detachment force and the base detachment force.

The head connection device 50 comprises a bayonet catch. In the exemplary embodiments, the head connection device 50 is a bayonet catch. The bayonet catch of the head connection device 50 comprises the male part 53 and the female part 54.

The head connection device 50 is designed such that it can be seen from outside whether it is in a closed state or in an open state. The head connection device 50 is designed such that the projection of the head element 22, in particular the male part 53, can be seen from outside the head connection device 50, in particular from outside the spraying device 2, in particular from outside the pressure cleaning device 1, when the head connection device 50 is closed. A window 55 is provided on the head lance element 32, in particular on the female part 54, as shown in FIG. 3. The window 55 is an aperture through an outer wall of the head lance element 52. When the head connection device 50 is closed, the outer wall at least partially encloses the head element 22. When the head connection device 50 is closed, the outer wall of the head lance element 32 runs at least partially enclosed around the head element 22 in a circumferential direction 98. The projection of the head element 22 is arranged in the area of the window 55 in the head lance element 52 when the head connection device 50 is closed. The locking recess 66 of the guide groove is arranged in the area of the window 55. In the exemplary embodiments, the locking recess 66 is part of the edge limit of the window 55. Through the window 55 it is possible to see from outside whether the head element 22 is within the head lance element 32 when the head connection device 50 is in the closed position. Through the window 55 it is possible to see from outside whether the male part 53 is within the female 54 when in the closed position.

The head detachment force must be applied against a head securing force provided by the head securing element 51 shown in FIG. 2. The base detachment force must be applied against a base securing force provided by the base securing element 41 shown The base detachment force to be applied to detach the base connection device is at least as great as the base securing force. Provision can also be made for the base detachment force to correspond to the base securing force. The head detachment force to be applied to detach the head connection device is at least as great as the head securing force. Provision can also be made for the head detachment force to correspond to the head securing force.

The spring hardnesses of the first spring, which forms the base securing element 41, and the second spring, which forms the head securing element 51, are of different magnitude. The spring hardness of the first spring is greater than the spring hardness of the second spring. In particular, the spring hardness of the first spring is at least 105%, in particular at least 120%, in particular at least 150% of the spring hardness of the second spring.

FIG. 6 shows the spraying device 2 or the pressure cleaning device 1 in a short state. In the short state, the spraying device 2 can be used without a lance 30. The spraying device 2 is designed such that the spraying head 20 can be fastened directly to the base body 10 without the interposition of the lance 30. This enables a direct connection between the base body 10 and the spraying head 20. The direct connection can be made by the interaction of the head element 22 of the head connection device 50 and the base element 12 of the base connection device 40. The head element 22 of the head connection device 50 corresponds to the base element 12 of the base connection device 40. In a way similar to that described in respect of the base connection device 40 and the head connection device 50 in FIGS. 3 to 5, the projection of the head element 22 can be inserted into the guide groove of the base element 12 and secured there, in particular by means of the base securing element 41. The head element 22 and the base element 12 together also form a bayonet catch.

When changing from the long state of the spraying device 2 shown in FIG. 1 to the short state of the spraying device 2 shown in FIG. 6, the spraying head 20 is first removed from the lance 30. To do this, the head connection device 50 is detached. The head securing force of the head securing element 51 must first be overcome here. This is done by the user applying the head detachment force. By means of the head detachment force, the head element 22 is moved against the longitudinal direction 100 towards the head lance element 52. In the process, the head securing element 51 designed as a second spring is compressed. The projection of the head element 22 is moved out of the locking recess 66 of the head lance element 52. The head element 22 can then be moved in a circumferential direction 98 in the guide groove. The head element 22 is pivoted in a circumferential direction 98 relative to the head lance element 52 and then removed from the head lance element 52 in the longitudinal direction 100. The projection of the head element 22 is moved here in the guide groove of the head lance element 52, first in the circumferential direction 98 and then in the longitudinal direction 100. After the spraying head 20 has been removed from the lance 30, the lance 30 is removed from the base body 10 in a similar manner. Because the head detachment force is smaller than the base detachment force, when detaching the spraying head 20 from the lance 30 there is no risk of the lance 30 detaching from the base body 10 before the spraying head 20 detaches from the lance 30. The user will initially only apply enough force to detach the head connection device 50. Only then, when detaching the lance 30 from the base body 10, will they apply more force in order to be able to detach the base connection device 40.

When replacing a first spraying head with a second spraying head, this also safely prevents the lance from being unintentionally detached from the base body instead of the spraying head being detached from the lance.

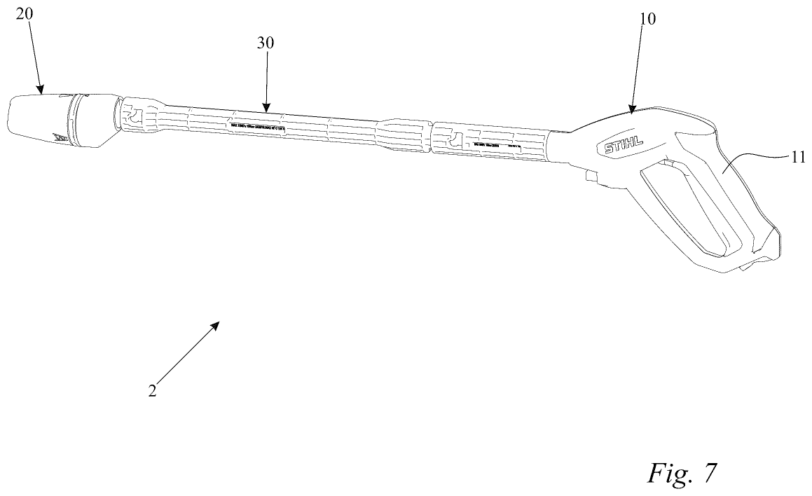

FIG. 7 shows an alternative exemplary embodiment of a spraying device 2. The spraying device 2 shown in FIG. 7 is part of a pressure cleaning device in which the pump is not integrated into the spraying device 2, but is fluidically connected to the spraying device 2 via a supply line. The spraying device 2 according to FIG. 7 also comprises a base body 10, a lance 30 and a spraying head 20. The spraying device 2 according to FIG. 7 also has a handle 11. The above description of the above exemplary embodiments according to FIGS. 1 to 6 applies analogously to a pressure cleaning device with a spraying device 2 according to FIG. 7, except for the arrangement of the pump.

What is claimed is:

1. A spraying device for a pressure cleaning device (1), the spraying device comprising:
a base body (10);
a spraying head (20) with a spraying opening (21) through which cleaning fluid can be sprayed;
a lance (30) capable of being arranged between the base body (10) and the spraying head (20);
a base connection device (40) by which the lance (30) can be detachably connected to the base body (10); and
a head connection device (50) by which the lance (30) can be detachably connected to the spraying head (20),
wherein the cleaning fluid is conveyed from the base body (10) to the spraying opening (21),
wherein the base connection device (40) is configured to be detached with a base detachment force,
wherein the head connection device (50) is configured to be detached with a head detachment force, and
wherein the base detachment force and the head detachment force are of different magnitude.

2. The spraying device according to claim 1,
wherein the head detachment force is smaller than the base detachment force.

3. The spraying device according to claim 1,
further comprising a second spraying head,
wherein the spraying device (2) is configured to be used with either the spraying head (20) or the second spraying head, and
wherein the spraying head (20) and the second spraying head have different properties.

4. The spraying device according to claim 1,
wherein the base connection device (40) comprises a base element (12) on the base body (10) and a base lance element (32) on the lance (30), and
wherein the head connection device (50) comprises a head element (22) on the spraying head (20) and a head lance element (52) on the lance (30).

5. The spraying device according to claim 1,
wherein the spraying head (20) is capable of being fastened directly to the base body (10) without interposition of the lance (30).

6. The spraying device according to claim 1,
wherein the base connection device (40) and/or the head connection device (50) comprises a bayonet catch.

7. The spraying device according to claim 1,
wherein the spraying device (2) comprises a base securing element (41) for securing the base connection device (40) against detachment and/or
wherein the spraying device (2) comprises a head securing element (51) for securing the head connection device (50) against detachment.

8. The spraying device according to claim 7,
wherein the base securing element (41) is a first spring, and
wherein the head securing element (51) is a second spring.

9. The spraying device according to claim 8,
wherein a spring hardness of the first spring and a spring hardness of the second spring are of different magnitude.

10. The spraying device according to claim 9,
wherein the spring hardness of the first spring is greater than the spring hardness of the second spring.

11. The spraying device according to claim 7,
wherein the lance (30) extends in a longitudinal direction (100) from the base body (10) to the spraying head (20), and
wherein the base securing element (41) and/or the head securing element (51) act in a longitudinal direction (100).

12. The spraying device according to claim 11,
wherein the base connection device (40) and/or the head connection device (50) comprises a bayonet catch,
wherein the base securing element (41) presses the base body (10) and the lance (30) apart with respect to the longitudinal direction (100) and/or
wherein the head securing element (51) presses the lance (30) and the spraying head (20) apart with respect to the longitudinal direction (100).

13. The spraying device according to claim 1,
wherein the base connection device (40) is designed for it to be visible from outside whether the base connection device (40) is in a closed state or in an open state, and/or
wherein the head connection device (50) is designed for it to be visible from outside whether the head connection device (50) is in a closed state or in an open state.

14. The spraying device according to claim 13,
wherein the base connection device (40) and/or the head connection device (50) comprises a bayonet catch,
wherein the bayonet catch has a male part (43, 53) and a female part (44, 54), and
wherein a window (45, 55) is provided on the female part (44, 54) so that it is visible from outside whether the male part (43, 53) is located inside the female part (44, 54) in the closed state.

15. A pressure cleaning device comprising a spraying device (2) according to claim 1.
